(19) United States
(12) Patent Application Publication
(10) Pub. No.: US 2026/0113361 A1
(43) Pub. Date: Apr. 23, 2026

(54) METHOD AND APPARATUS OF SELECTING A NETWORK FUNCTION OF SESSION MANAGEMENT

(71) Applicant: LENOVO (BEIJING) LIMITED, Beijing (CN)

(72) Inventors: Tingfang TANG, Beijing (CN); Haiyan LUO, Shanghai (CN)

(21) Appl. No.: 19/111,553

(22) PCT Filed: Sep. 30, 2022
(86) PCT No.: PCT/CN2022/123552

§ 371 Date: Mar. 13, 2025

(51) Int. Cl. H04L 65/1069; H04L 45/30; H04L 69/322

(52) U.S. Cl. CPC H04L 65/1069; H04L 45/30; H04L 69/322

(57) ABSTRACT

Embodiments of the present application relate to a method and apparatus of selecting an NF of session management. An exemplary NF of access and mobility management may include: a transceiver; and a processor coupled to the transceiver, wherein the processor is configured to: determine common DNAI for a UE of a collection of UEs configured to use same DNAI during a procedure of PDU session establishment for the UE; and determine an NF of session management for the UE based on the common DNAI during the procedure of PDU session establishment.

### TECHNICAL FIELD

Embodiments of the present application are related to wireless communication technology, and more particularly, related to a method and apparatus of selecting a network function (NF) of session management.

### BACKGROUND

Wireless communication technologies have been developed to support edge computing within 5G architecture. In edge computing deployment, one application service may be served by multiple edge application servers (EAS) typically deployed in different sites. These multiple EAS instances that host the same content or service may use a single Internet protocol (IP) address (anycast address) or different IP addresses. User equipment (UE) accesses an application server (AS) via a user plane (UP) function (UPF), which is used as a protocol data unit (PDU) session anchor (PSA). PDU sessions are established between the UE and the PSA UPF. One PDU session may support one or more applications. Before an application or UE starts to connect to the service, it is very important for the application or UE to discover an IP address of a suitable EAS (e.g., the one closest to the UE), so that the traffic can be locally routed to the EAS via uplink classifier (UL CL) or branching point (BP) mechanisms or a PDU session established directly with the local data network (DN) where the EAS is deployed, and service latency, traffic routing path and user service experience can be optimized.

In the work for FS_EDGE_Ph2 in 3rd generation partnership project (3GPP) Release (Rel) 18, KI #4: influencing UPF and EAS (re) location for collections of UEs are discussed. The key issues in KI #4 correspond to Work Task #6 in SP-211638, which will investigate the potential need and solutions to influence of PSA-UPF and EAS (re) location for collection of UEs, e.g. in scenarios when UE(s) should use the same EAS and are not members of a pre-defined group. In particular, the key issue will study the following aspects:
whether and how to define a collection of UEs forming a dynamic ad-hoc group that should use the same EAS and/or same local part of DN and/or same data network access identifier (DNAI) and how the collection is identified;
whether and how to influence UPF and EAS (re) location for a collection of UEs that should use the same EAS and/or same local part of DN and/or same DNAI;
how to decide on a common local part of DN for the collection of UEs;
how to handle coordination of the UPF(s) and EAS (re) location for collections of UEs;
whether and how existing mechanisms suffice; and
whether and what improvements are required for EAS discovery and re-discovery for UEs belonging to a collection of UEs.

Thus, there are several technical problems concerning a collection of UEs that should use the same EAS and/or same local part of DN and/or same DNAI need to be solved, e.g., how to select an SMF for a UE of the collection of UEs during the PDU session establishment procedure should considering the same EAS and/or same local part of DN and/or same DNAI when available.

### SUMMARY

One objective of the present application is to provide a solution of selecting an NF of session management, e.g., a method and apparatus of selecting an NF of session management, especially for a UE of a collection of UEs that should use the same EAS and/or same local part of DN and/or same DNAI.

Some embodiments of the present application provide an NF of access and mobility management, e.g., an access and mobility management function (AMF), which includes a transceiver; and a processor coupled to the transceiver, wherein the processor is configured to: determine common DNAI for a UE of a collection of UEs configured to use same DNAI during a procedure of PDU session establishment for the UE; and determine an NF of session management for the UE based on the common DNAI during the procedure of PDU session establishment.

Some other embodiments of the present application provide a method of selecting an NF of session management, e.g., by an AMF, which includes: determining common DNAI for a UE of a collection of UEs configured to use same DNAI during a procedure of PDU session establishment for the UE; and determining an NF of session management for the UE based on the common DNAI during the procedure of PDU session establishment.

In some embodiments of the present application, the common DNAI for the UE is received from an NF of unified data repository, or is retrieved from the NF of unified data repository, or is stored in the NF of access and mobility management.

According to some embodiments of the present application, information related to the common DNAI is managed as group data or as subscription data for each UE or as part of traffic routing information for the UE collection.

In some embodiments of the present application, the common DNAI for the UE is received from an NF of session management previously selected for the UE.

According to some embodiments of the present application, information related to the common DNAI is managed as group data or as traffic routing information

According to some embodiments of the present application, the information related to the common DNAI is associated with at least one of a group identity or correlation information indicating the collection of UEs configured to use the same DNAI.

According to some embodiments of the present application, the information related to the common DNAI is associated with at least one collection of UEs managed in a group. Each collection of UEs in the group is associated with an identifier of collection.

In some embodiments of the present application, the processor is configured to: transmit the common DNAI to the determined NF of session management.

In some embodiments of the present application, the processor is configured to: transmit, to the UE, a domain name service (DNS) server determined based on the common DNAI during the PDU session establishment procedure.

In some embodiments of the present application, the processor is configured to: transmit, to the UE, a DNS server determined based on a changed common DNAI of the collection of UEs during lifetime of the established PDU session.

In some embodiments of the present application, in the case that the collection of UEs configured to use same DNAI is a collection of UEs using the same EAS, the same EAS will be mapped to a same DNAI.

In conclusion, embodiments of the present application provide solutions improving influence of PSA-UPF and EAS (re) location for a collection of UEs, e.g. in scenarios when the collection of UE(s) should use the same EAS and/or same local part of DN and/or same DNAI, and thus being advantageous in user experience and cost etc.

### BRIEF DESCRIPTION OF THE DRAWINGS

In order to describe the manner in which advantages and features of the present application can be obtained, a description of the present application is rendered by reference to specific embodiments thereof which are illustrated in the appended drawings. These drawings depict only exemplary embodiments of the present application and are not therefore intended to limit the scope of the present application.

FIG. 1 illustrates an exemplary network architecture supporting edge computing, in accordance with some embodiments of the present application.

FIG. 2 illustrates a flow chart of a method of selecting an NF of session management according to some embodiments of the present application.

FIG. 3 illustrates an exemplary procedure of selecting an SMF in scenarios 1 according to some embodiments of the present application.

FIG. 4 illustrates an exemplary procedure of selecting an SMF in scenarios 2 according to some embodiments of the present application.

FIG. 5 illustrates an exemplary block diagram of an apparatus of routing control according to some embodiments of the present application.

FIG. 6 illustrates an exemplary block diagram of an apparatus of routing control according to some other embodiments of the present application.

### DETAILED DESCRIPTION

The detailed description of the appended drawings is intended as a description of the currently preferred embodiments of the present application and is not intended to represent the only form in which the present application may be practiced. It is to be understood that the same or equivalent functions may be accomplished by different embodiments that are intended to be encompassed within the spirit and scope of the present application.

In the following description, numerous specific details are provided, such as examples of programming, software modules, network transactions, database structures, hardware modules, hardware circuits, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference will now be made in detail to some embodiments of the present application, examples of which are illustrated in the accompanying drawings. To facilitate understanding, embodiments are provided under specific network architecture and new service scenarios, such as 3GPP 5G, 3GPP Long Term Evolution (LTE) and so on. Persons skilled in the art know very well that, with the development of network architecture and new service scenarios, the embodiments in the present application are also applicable to similar technical problems; and moreover, the terminologies recited in the present application may change, which should not affect the principle of the present application.

FIG. 1 illustrates an exemplary network architecture 100 supporting traffic offloading. The network architecture 100 includes several NFs, in which the techniques, processes and methods described herein can be implemented, in accordance with various embodiments. An NF may be implemented either as a network element on a dedicated hardware, as a software instance running on a dedicated hardware, or as a virtualized function instantiated on an appropriate platform, e.g., a cloud infrastructure. A single NF may be implemented by a single entity or multiple entities in conjunction.

Seen from the core network side, the network architecture 100 shown in FIG. 1 includes a network exposure function (NEF) 102, a policy control function (PCF) 104, an application function (AF) 106, an AMF 108, and an SMF 110. Nnef is a service-based interface exhibited by the NEF 102. Npcf is a service-based interface exhibited by the PCF 104. Naf is a service-based interface exhibited by the AF 106. Namf is a service-based interface exhibited by the AMF 108. Nsmf is a service-based interface exhibited by the SMF 110.

Seen from the access side, the network architecture 100 shown in FIG. 1 includes a UE 112 connected to an access network (AN) 114 and the AMF 108. The UE 112 communicates with the AMF 108 via an interface N1. The AN 114 includes one or more base stations (BSs) (not shown), e.g., enhanced or evolved Node Bs (eNBs), 5G base stations (gNBs) or the like. The AN 114 may connect to a first DN 122 via a first UPF 116 and a second UPF 118, and to a second DN 124 via the first UPF 116 and a third UPF 120. The AN 114 communicates with the AMF 108 via an interface N2, and communicates with the first UPF 116 via an interface N3. A UPF to steer a traffic can be a UL CL or BP UPF, e.g., the first UPF 116 when there are multiple PSA UPFs, e.g., the second UPF 118 and the third UPF 120 for a PDU session. The UL CL or BP UPF can be a standalone UPF or be co-located with a PSA UPF. The UPF to steer a traffic can also be a PSA UPF or a UPF of N3 terminating point when there is only one PSA UPF for a PDU session, that is, there is no UL CL or BP UPF. The SMF 110 may make routing decisions for traffic of PDU sessions. For example, the SMF 110 may decide to select which one of the first UPF 118 and the second UPF 120 as a PSA for traffic. The first UPF 116, second UPF 118 and third UPF 120 communicate with the SMF 110 via an interface N4, respectively. The UPF 116 communicates with the second UPF 118 and third UPF 120 via an interface N9, respectively. The second UPF 118 and third UPF 120 communicate with the first DN 122 and second DN 124 via an interface N6, respectively. Although only one UE and two DNs are depicted in FIG. 1, it is contemplated that any number of UEs and DNs may be included in the network architecture 100. Further, the network architecture 100 may also include other components, for example, other NFs not shown in FIG. 1.

Service (or application or the like) providers may deploy applications into one or more DNs, e.g., an edge DN which is a local part of the DN or local access of the DN, or a central DN. The applications may be served by one or more EASs 126 deployed in a DN, e.g., the second DN 124. Other DNs, e.g., the first DN 122 may also include one or more EAS. Multiple EAS instances that host the same content or service may use a single IP address (anycast address) or different IP addresses. The IP address of a suitable EAS (e.g., the one closest to the UE) will be discovered for the application or UE, so that the traffic can be locally routed to the EAS. The AF 106 can get the traffic routing information (TRI) for the deployed applications. Thus, traffic routing control is very important for optimizing service latency, traffic routing path and user service experience.

To enhance traffic routing control, in the work for FS_EDGE_Ph2 in 3GPP R18, key issue (KI) #3: policies for finer granular sets of UEs and KI #4: influencing UPF and EAS (re) location for collections of UEs are discussed. According to KI #4, 3GPP will investigate the potential need and solutions to influence of PSA-UPF and EAS (re) location for collection of UEs, e.g. in scenarios when UE(s) should use the same EAS and are not members of a pre-defined group.

Influencing UPF and EAS (re) location for collections of UEs mainly focuses on controlling using the same DNAI/EAS information for a collection (or a set or a group) of UEs. Related information includes target DNAI/EAS and/or indication indicating using the same DNAI/EAS for the collection of UEs. Information related to the same DNAI/EAS can be available in the following scenarios:
SMF gets configuration with the indication that the collection of UEs should use the same DNAI/EAS. This information can be received from the AF or PCF or unified data management (UDM)/unified data repository (UDR) or locally, per UE or per group. If the information is managed as group subscription data, it can be sent from the AF and further stored in the UDM/UDR and then sent to the SMF. If the information is managed as part of traffic routing information, it can be sent from the AF and stored in the UDM/UDR and sent to the PCF and can be further sent to the SMF (e.g. via policy and charging control (PCC) rule from PCF). After receiving the information, the SMF can use the common DNAI/EAS if available, or select the common DNAI/EAS used for the collection of UEs and notify the information to the UDM and may be further stored in the UDR.
SMF gets configuration with the target DNAI/EAS information that the collection of UEs should use for the application(s). This information can be configured from the AF per UE or per group, or be determined locally by the SMF or other related NF, or retrieved from UDM/UDR.
   Based on the above information, SMF may use the target DNAI/EAS for the user plane path (re) location, EAS discovery etc.

According to KI #4, some specific items to be studied include but not limited to the following: whether and how to define a collection of UEs forming a dynamic ad-hoc group that should use the same EAS and/or same local part of DN and/or same DNAI and how the collection is identified; and whether and how to influence UPF and EAS (re) location for a collection of UEs that should use the same EAS and/or same local part of DN and/or same DNAI. In an exemplary scenario, after the same EAS and/or same local part of DN and/or same DNAI is used by one of the UEs within the collection of UEs, the successive PDU sessions for other UEs within the collection of UE are supposed to access the same local part of DN or the same DNAI.

Given the above issues, some embodiments of the present application propose a technical solution of selecting an NF of session management selection, e.g., SMF for a UE of a collection of UEs configured to use same DNAI during the PDU session establishment procedure, wherein a common DNAI for the collection of UEs will be considered if available.

Since the same local part of DN can be accessed via specifically corresponding DNAI(s), so the same local part of DN can deemed as UEs using the same DNAI. In addition, since an EAS will be accessed via specifically corresponding DNAI(s) too, so the EAS can be mapped to a DNAI to provide services for UEs, UEs using the same EAS can also be deemed as UEs using the same DNAI. Thus, “the same local part of DN and/or same DNAI” can be deemed as “the same DNAI,” “the same EAS/DNAI” or “the same DNAI/EAS” can be deemed as “the same DNAI” and “the same EAS and/or same local part of DN and/or same DNA” can be deemed as “the same EAS/DNAI,” or “the same DNAI/EAS” or “the same DNAI.” Given that, a collection of UEs configured to (or supposed to, or should, or the like) use the same DNAI refers to a collection of UEs (or a group of UEs, or a set of UEs, or the like) that should use the same EAS and/or same local part of DN and/or same DNAI (that is, at least one of EAS, local part of DN or DNAI used by the UE is the same). Accordingly, a common DNAI refers to the same DNAI corresponding to the same local part of DN and/or same DNAI and/or the same EAS. A collection of UEs configured to use the same DNAI will access data network name (DNN) and single network slice selection assistance information (S-NSSAI) via the common DNAI.

For an NF, information related to common DNAI can be achieved (or available) in various manners, e.g., receiving from the AF, being determined by the SMF when a UE within of the collection of UEs is accessing the DNN or S-NSSAI, or being configured locally etc., which are similar to all existing solutions for the same DNAI/EAS. If a common EAS other than common DNAI is available within 5GC in the UDM/UDR, or in the SMF etc., the related common DNAI can be deduced based the configuration information, or EAS deployment information (EDI), or traffic routing information, or any combination of the above information.

Information related to common DNAI of a collection of UEs can be managed as a part of traffic routing information for the collection of UEs, or as group data (e.g., group subscription data), which is based on each collection of UEs, or as subscription data for each UE in the traffic routing information for the collection of UEs. Exemplary group data is associated with at least one of a group identity or correlation information indicating the collection of UEs configured to use the same DNAI. In some scenarios, the group data is associated with at least one collection of UEs managed in a group. Each collection of UEs in the group is associated with an identifier of collection.

For example, the information related to the common DNAI may be stored as a part of group data in the UDM/UDR for the collection of UEs configured to use the same DNAI, where the collection of UEs are managed as an internal group within 5GC with an internal group ID. The related internal group ID is included in the UE subscription data of each UE of the collection of UEs. Each internal group will be indicated whether it requires using the same DNAI for the UEs within the group, for example, by using a special group ID or group type or correlation information indicating the requirement of using the same DNAI or by configuration.

In some embodiments of the present application, to achieve a finer granularity, the group data may further include correlation information indicating using the same DNAI for UEs within the group with an identifier to differentiate different collections of UEs using the same DNAI, or to differentiate different groups including more than one collection of UEs using the same DNAI. In some scenarios, correlation information can be used with any UE to indicate using the same DNAI for a UE collection. Additional information used to identify the UE collection is various, e.g., being at least one of spatial information, temporal information, subscriber category, allowed services, or other application specific information or the like.

Exemplary group subscription data related to the common DNAI of a collection of UEs is illustrated in table 1, which extends the existing 5G virtual network (VN) group data by adding parameters “Correlation with Same DNAI for multiple PDU sessions” and “common DNAI/EAS,” and respective description of the two parameters.

TABLE 1

| Parameters | Description |
|---|---|
| DNN | DNN for the group |
| S-NSSAI | S-NSSAI for the group |
| PDU Session Type | PDU Session Types allowed for the group |
| Application descriptor | There may be multiple instances of this |
| | information; this information may be used to build |
| | URSP sent to group members |
| Information related with | This may indicate: |
| secondary authentication / | the need for secondary |
| authorization | authentication/authorization (as defined in |
| | clause 5.6 of TS 23.501 [2]); |
| | the need for SMF to request the UE IP address |
| | from the DN-AAA Server. |
| | If at least one of secondary |
| | authentication/authorization or DN-AAA UE IP |
| | address allocation is needed, the AF may provide |
| | DN-AAA Server addressing information. |
| Correlation with same | This indicates whether the same DNAI for PDU |
| DNAI for multiple PDU | sessions related to the internal group to access the |
| sessions | same DNN and S-NSSAI/application is required. |
| Common DNAI/EAS | This indicates Common DNAI/EAS for PDU |
| | sessions related to the internal group to access the |
| | same DNN and S-NSSAI/application. |

In some other embodiments of the present application, group data related to the common DNAI of a collection of UEs is managed in another group data structure, e.g., a group data structure totally different from table 1, which also includes description on “DNN,” “S-NSSAI,” “common DNAI/EAS,” and “the information to identify the collection of UEs using the same DNAI/EAS” etc.

In the case that the information related to the common DNAI is managed as subscription data of each UE of a collection of UEs configured to use the same DNAI, the common DNAI may be configured as SMF selection subscription data. Exemplary SMF selection subscription data for each UE within the collection of UEs configured to use the same DNAI is illustrated in table 2, wherein a new field “Correlation with Same DNAI for multiple PDU sessions” is introduced into for subscription data type of “SMF selection subscription data,” which is data needed for SMF selection.

TABLE 2

| Subscription | | |
|---|---|---|
| data type | Field | Description |
| . . . | | |
| SMF | SUPI | Key |
| Selection | SMF Selection Subscription data contains one or more S-NSSAI | |
| Subscription | level subscription data: | |
| data | S-NSSAI | Indicates the value of the S-NSSAI. |
| | Subscribed DNN list | List of the subscribed DNNs for the UE |
| | | (NOTE 1). |
| | . . . | |
| | SMF information for static | When static IP address/prefix is used, |
| | IP address/prefix | this may be used to indicate the |
| | | associated SMF information per (S- |
| | | NSSAI, DNN). |
| | Correlation with Same | Indicates whether the same DNAI for |
| | DNAI for multiple PDU | PDU sessions to access the same DNN |
| | sessions | and S-NSSAI is required. |
| | | The target DNAI may be included too. |
| UE context | SUPI | Key. |
| in SMF | PDU Session Id(s) | List of PDU Session Id(s) for the UE. |
| data | . . . | |
| . . . | | |

Persons skilled in the art should well know that both table 1 and table 2 are only used as examples for clear illustration, and should not be used to unduly limit the scope of the present application.

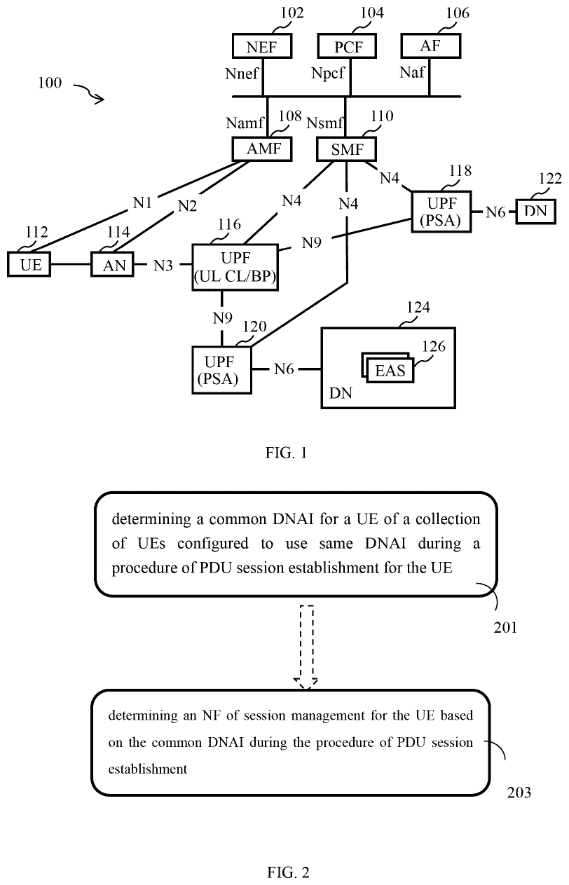

FIG. 2 illustrates a flow chart of a method of selecting an NF of session management, e.g., SMF or the like, according to some embodiments of the present application, which can be performed by an NF of access and mobility management or the like, e.g., an AMF 108 shown in FIG. 1 or the like. Persons skilled in the art should well know although the embodiments are illustrated in view of AMF and SMF, they can be applied to other NFs with similar functions.

Referring to FIG. 2, in step 201, an AMF or the like will determine a common DNAI for a UE of a collection of UEs configured to use same DNAI during a procedure of PDU session establishment (e.g., a PDU Session Establishment procedure provided in 3GPP or the like) for the UE. The PDU session can be any kind of PDU session, including but not limited to: PDU session with multiple anchors using UL CL or multi-homing, service and session continuity (SSC) mode 1 PDU session, SSC mode 2 PDU session, and SSC mode 3 session etc.

The AMF can determine the common DNAI for the UE in various manners. For example, in some embodiments of the present application, when selecting an SMF for the UE in the first time during a procedure of PDU session establishment for the UE, the common DNAI is available for the AMF (hereafter scenarios 1), which may be received from an NF of unified data repository (e.g., UDM and/or UDR (UDM/UDR) or the like), or retrieved from the NF of unified data repository, or is locally stored in the AMF. In some other embodiments of the present application, the AMF may determine the common DNAI for the UE from information indicating SMF reselection for the UE. For example, when selecting an SMF for the UE during a procedure of PDU session establishment in the first time, the common DNAI is unavailable for the AMF, and the AMF may select an SMF for the UE not based on the common DNAI. However, a common DNAI for the UE is available for the selected SMF, and the selected SMF discovers that another SMF should be reselected for the UE based on the common DNAI. Then, the selected SMF will indicate an SMF reselection to the AMF with the common DNAI (hereafter, scenarios 2). Accordingly, the AMF will determine the common DNAI for the UE from the information related to SMF reselection from the SMF.

In step 203, the AMF will determine an SMF for the UE based on the determined common DNAI during the procedure of PDU session establishment. For example, in scenarios 1, the SMF is an SMF firstly determined based on the determined common DNAI; and in scenarios 2, the SMF is an SMF reselected based on the determined common DNAI.

In some embodiments of the present application, when the common DNAI for a UE of a collection of UEs configured to use the same DNAI is available for the AMF, the AMF may transmit the common DNAI to an SMF, e.g., the SMF selected for the UE for usage in the SMF. For example, the SMF may use the common DNAI as a target DNAI, or use the common DNAI for selecting a DNS server for the UE etc.

More detailed embodiments of the present application will be illustrated in the following respectively in view of exemplary kinds of PDU session in scenarios 1 and scenarios 2. Persons skilled in the art should well know how to apply the disclosed technical solutions to other kinds of PDU sessions under the illustrated disclosure and teaching. In addition, the illustrated embodiments mainly focus on how to select (including reselect) an SMF for a UE based on a common DNAI, and some prior or common steps or details are omitted herein. Persons skilled in the art should well know that although some procedures illustrated in embodiments of the present application have been defined in current 3GPP specification, they may evolve in the future as 3GPP develops while still be adaptive to the technical solution sought to be protected by the present application. Scope of the present application should not be unduly limited to the specific steps of the exemplary procedures.

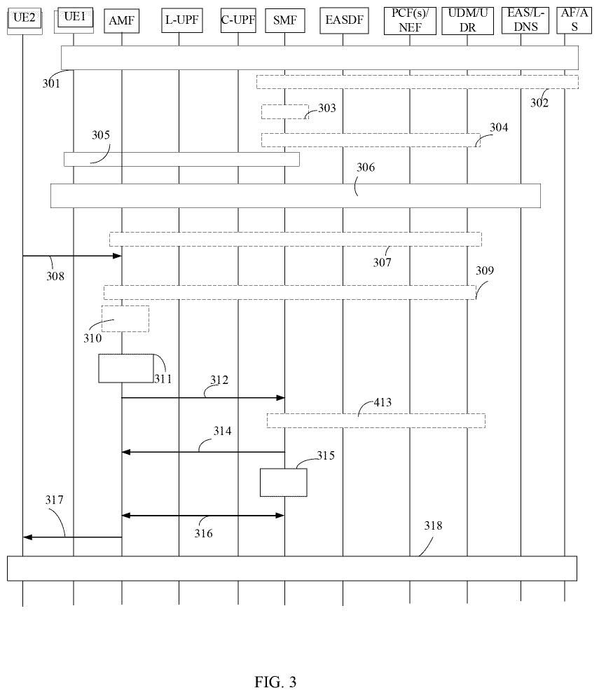

FIG. 3 illustrates an exemplary procedure of selecting SMF in scenarios 1 according to some embodiments of the present application. Herein, taking a PDU session with multiple anchors using UL CL as an example, and the local PDU session anchor is L-UPF selected based on traffic routing information.

Referring to FIG. 3, in step 301, a UE, e.g., UE1 of a collection of UEs configured to use the same DNAI establishes a PDU session with the C-UPF and communicate with the AS for applications, which is identical or similar to legacy technology. It is assumed that UE1 is the first UE of the collection accessing the network for applications. When the AMF selects the SMF for UE1, the common DNAI for the collection of UE1 is unavailable at least for the AMF, and thus the SMF selected for UE1 is not based on common DNAI.

For the collection of UEs including UE1, a common DNAI may be determined in various manners and stored in the UDM/UDR. The common DNAI will be sent to the SMF or AMF. As illustrated in steps 302 to 304, the DNAI/EAS relocation for the collection of UEs is triggered by the AF or SMF, which is identical or similar to legacy. In step 303, the SMF will decide DNAI relocation to a common DNAI, and the common DNAI will be stored in the UDM/UDR.

In some other embodiments of the present application, the common DNAI may be determined before establishing a PDU session for UE1, and the SMF for UE1 will be selected based on the common DNAI in a manner similar to that illustrated for UE2 below.

In steps 305 and 306, the SMF selected for UE1 will control the traffic routing based on the related information and common DNAI accordingly, which is identical or similar to legacy. For example, UL CL and L-UPF may be established by the SMF for local access via the C-UPF. In step 306, user-plane communication will take place between the application client in UE1 and EAS via the L-UPF after the application relocation to the EAS.

In step 308, another UE, e.g., UE2 initiates a PDU session establishment request to access the same DN as UE1. UE2 also belongs to the same collection of UEs including UE1, e.g., using the same EAS, and/or same DNAI, and/or same local part of the DN as UE1.

The common DNAI for the same collection of UEs will be available in the AMF when the AMF selects the SMF for UE2. The AMF will determine the common DANI for UE2 and select an SMF for UE2 based on the common DNAI, which may be the same as the SMF previously selected for UE1 or a different SMF. In such a manner, it can be ensured that any UE of the collection of UEs, which accesses the network after UE1 will use the same common DNAI.

The common DNAI for UE2 can be determined in various manners by the AMF. The information related to the common DNAI can be managed as group data (e.g. group subscription data) or as subscription data for each UE.

For example, the common DNAI may be received from the UDM/UDR. In step 307 (which may follow other steps, e.g., after step 304 in some scenarios), information related to the common DNAI, e.g., information of identifying the collection of UEs using the same DNAI, and/or information related to the common DNAI for the DNN/S-NSSAI in the UDM/UDR will be sent to the AMF. If the information related to the common DNAI is managed as group data, e.g., group subscription data, it may be sent or updated to the AMF, e.g., by Nudm_SDM_Notification service operation using the Shared Data feature defined in TS 29.503. If the information related to the common DNAI is managed as subscription data for each UE, e.g., SMF selection subscription data for each UE, it may be sent or updated to the AMF during or after the UE registration procedure while retrieving subscription data for the UE, e.g., via Nudm_SDM_Get operation, or be notified via Nudm_SDM_Notification operation based on the related subscription data.

According to some other embodiments of the present application, the AMF may retrieve the information related to the common DNAI from the UDM/UDR. For example, the UE is indicated to use common DNAI, but there is no corresponding common DNAI. Then, the AMF may be triggered to retrieve the common DNAI from the UMD/UDR.

According to some yet other embodiments of the present application, the common DNAI for the collection of UE has been available in the AMF. For example, in step 309, the information related to the common DNAI is managed as group data, and the UE is determined belonging to a group (at least including the collection) based on the related information of identifying the collection of UEs as described above, the common DNAI will be applied to the UE by the AMF.

After the common DNAI is determined for UE2, the AMF will select an SMF for UE2 based on the common DNAI in step 311.

Then, in step 312, the AMF will invokeNsmf_PDUSession_CreateSMContext Request service operation of the SMF, and the SMF will respond to the AMF by invoking Nsmf_PDUSession_CreateSMContext Response service operation, which is identical or similar to legacy. In some scenarios, the AMF may include the common DNAI in the Nsmf_PDUSession_CreateSMContext Request, and the common DNAI may be implemented using the target DNAI or a new parameter in the Nsmf_PDUSession_CreateSMContext Request.

In step 315, the SMF will select the UPF using the common DNAI if available, which may be received via step 312 from the AMF or via step 13 from the UDM/UDR or via the related information stored in SMF. If the edge application server discovery function (EASDF) will be selected, the common DNAI may also be used for EASDF selection. The SMF may also use the common DNAI for other usage.

In steps 316 and 317, the message of PDU Session Establishment Accept will be sent to the UE, and the PDU session is established for UE2. A DNS server selected by the SMF, e.g., based on common DNAI may be transmitted to the UE via the AMF if the EASDF is not used, otherwise the EASDF selected is sent to the UE.

During the lifetime of the PDU session, traffic routing and EAS discovery may be performed based on the common DNAI in step 318, which includes at least one of the following:
Traffic routing considering the common DNAI, e.g. for UL CL and L-PSA insertion, change, removal, and for PSA change for SSC modes 2 and 3 etc.
The DNS server based on common DNAI, which changes during the lifetime of the PDU session, is updated to the UE during the PDU session lifetime.
Constructing DNS handling rules using the common DNAI which is configured to the EASDF when the EASDF is used.

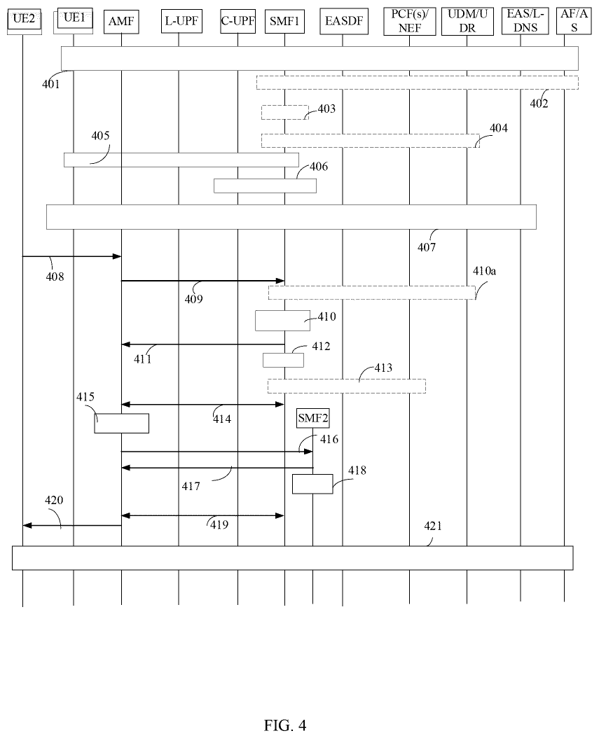

FIG. 4 illustrates an exemplary procedure of selecting SMF in scenarios 2 according to some embodiments of the present application. Herein, taking a PDU session with multi-homing as an example, and the local PDU session anchor is L-UPF selected based on traffic routing information.

Referring to steps 401 to 407, a UE, e.g., UE1 of a collection of UEs will establish the PDU session with the C-UPF and relocate based on the common DNAI, wherein steps 401 to step 405 and step 7 respectively correspond to steps 301 to 306 in FIG. 3. Regarding step 406, it is related to C-UPF updating, which is identical to the legacy.

In step 408, another UE, e.g., UE2, which also belongs to the same collection of UEs including UE1, initiates a PDU session establishment request to access the same DN as UE1.

However, the AMF has no idea on common DNAI that UE2 should use, and thus will select an SMF, e.g., SMF1 (unrelated to that selected for UE1) for UE2 without considering the common DNAI, and send the request to the selected SMF in step 409 by invoking Nsmf_PDUSession_CreateSMContext Request service operation. Accordingly, SMF1 will respond by invoking Nsmf_PDUSession_CreateSMContext response service operation to the AMF in step 411.

However, in some scenarios, in step 410, the information related to usage of common DNAI may be available in the SMF, which may be managed as group data or as part of traffic routing information. In an exemplary scenario, in step 410a, the SMF may retrieve the information related to the common DNAI from the UDM/UDR, e.g., as group data. In another exemplary scenario, UE2 is determined to belong to a group based on the related information of identifying the collection of UEs as described above, and the information related to the common DNAI may also be available in the SMF, e.g., as date related to other UEs, e.g., UE1 in the SMF. Based on the related data, UE2 is determined to be associated with UE1 and should use the same DNAI, and the common DNAI will be applied to UE2.

If the SMF determines that it cannot serve the common DNAI, the SMF will include the common DNAI in the Nsmf_PDUSession_CreateSMContext Response, which will trigger a SMF reselection for the PDU session for UE2 performed in step 415. The common DNAI may be implemented as the target DNAI in Nsmf_PDUSession_CreateSMContext Response, or as a new parameter.

In some scenarios, the SMF may select the PCF for the PDU session as legacy in step 412. However, the SMF may retrieve the information related to the common DNAI as a part of PCC rule in step 413, wherein the PCC rule may be based on the traffic routing information received by the PCF, the traffic routing information including common DNAI may be sent from the AF, stored in the UDM/UDR and further sent to the PCF. The information related to the common DNAI may also be available in the SMF, e.g., as data related for other UEs, e.g., UE1 in the SMF. UE2 is determined (e.g. based on the related information received in the PCC rule) to be associated with UE1 with using the same DNAI, and the common DNAI will be applied to the UE.

Similarly, in step 414, if the SMF determines that it cannot serve the common DNAI (or the collection of UEs using the common DNAI), the SMF will include the common DNAI in the message of Nsmf_PDUSession_SMContextStatusNotify, which will trigger a SMF reselection for the PDU session for UE2 performed in step 415. The common DNAI may be implemented as the target DNAI in the message of Nsmf_PDUSession_SMContextStatusNotify or a new parameter.

In step 415, the AMF will reselect an SMF, e.g., SMF2 for UE2 based on the DNAI received from SMF1 (the previously selected SMF).

Then, in step 416, the AMF will invoke Nsmf_PDUSession_CreateSMContext Request service operation of the SMF, and the SMF will respond to the AMF by invoking Nsmf_PDUSession_CreateSMContext Response service operation in step 417, which is identical or similar to legacy. In some scenarios, the AMF may include the common DNAI in the Nsmf_PDUSession_CreateSMContext Request, and the common DNAI may be implemented using the target DNAI in the Nsmf_PDUSession_CreateSMContext Request or a new parameter.

In step 418, the SMF will select the UPF using the common DNAI if available, which may be received via step 415. If the EASDF will be selected, the common DNAI may also be used for EASDF selection.

In steps 419 and 420, the message of PDU Session Establishment Accept will be sent to UE2, and the PDU session is established for UE2. The DNS server selected by the SMF based on common DNAI may be transmitted to the UE via the AMF if the EASDF is not used, otherwise the EASDF is sent to the UE.

During the lifetime of the PDU session, traffic routing and EAS discovery may be performed based on the common DNAI in step 421, which is also similar to step 318 illustrated in FIG. 3, and thus will not repeat.

Besides methods of selecting SMF or the like, some embodiments of the present application also provide an apparatus of selecting SMF or the like.

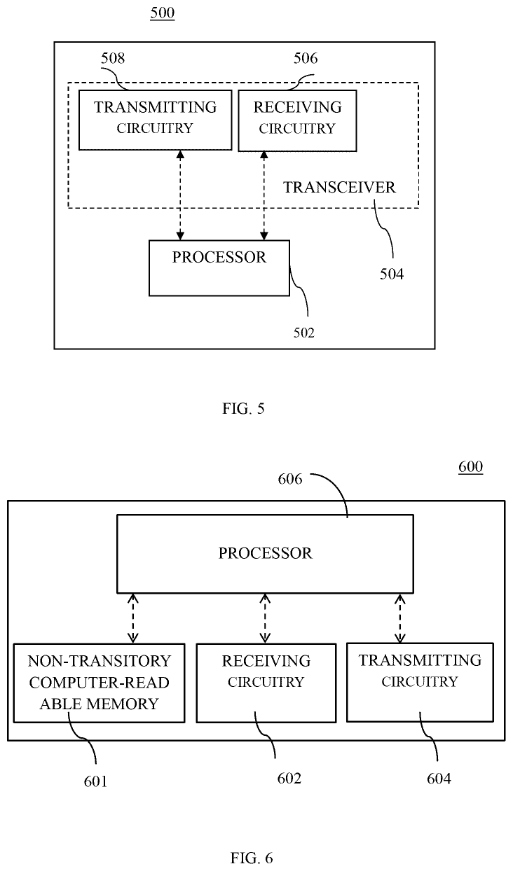

For example, FIG. 5 is a block diagram of an apparatus of selecting an NF of session management according to some embodiments of the present application.

Referring to FIG. 5, the apparatus 500, for example an AMF may include at least one processor 502 and at least one transceiver 504 coupled to the at least one processor 502. The transceiver 504 may include at least one separate receiving circuitry 506 and transmitting circuitry 508, or at least one integrated receiving circuitry 506 and transmitting circuitry 508. The at least one processor 502 may be a CPU, a DSP, a microprocessor etc.

According to some embodiments of the present application, the processor is configured to: determine common DNAI for a UE of a collection of UEs configured to use same DNAI during a procedure of PDU session establishment for the UE; and determine an NF of session management for the UE based on the common DNAI during the procedure of PDU session establishment.

FIG. 6 illustrates a block diagram of an apparatus of selecting an NF of session management 600 according to some other embodiments of the present application.

As shown in FIG. 6, the apparatus 600 may include at least one non-transitory computer-readable medium 601, at least one receiving circuitry 602, at least one transmitting circuitry 604, and at least one processor 606 coupled to the non-transitory computer-readable medium 601, the receiving circuitry 602 and the transmitting circuitry 604. The at least one processor 06 may be a CPU, a DSP, a microprocessor etc. The apparatus 600 may be an AMF configured to perform a method illustrated in the above or the like.

Although in this figure, elements such as the at least one processor 606, transmitting circuitry 604, and receiving circuitry 602 are described in the singular, the plural is contemplated unless a limitation to the singular is explicitly stated. In some embodiments of the present application, the receiving circuitry 602 and the transmitting circuitry 604 can be combined into a single device, such as a transceiver. In certain embodiments of the present application, the apparatus 600 may further include an input device, a memory, and/or other components.

In some embodiments of the present application, the non-transitory computer-readable medium 601 may have stored thereon computer-executable instructions to cause a processor to implement the method with respect to the UE as described above. For example, the computer-executable instructions, when executed, cause the processor 606 interacting with receiving circuitry 602 and transmitting circuitry 604, so as to perform the steps with respect to the AMF as depicted above.

The method according to embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device capable of implementing the flowcharts shown in the figures may be used to implement the processor functions of this application. For example, an embodiment of the present application provides an apparatus, including a processor and a memory. Computer programmable instructions for implementing a method are stored in the memory, and the processor is configured to perform the computer programmable instructions to implement the method. The method may be a method as stated above or other method according to an embodiment of the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method as stated above or other method according to an embodiment of the present application.

In addition, in this disclosure, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The terms “having,” and the like, as used herein, are defined as “including.”

1. A network function (NF) of access and mobility management, comprising:
at least one memory; and
at least one processor coupled with the at least one memory and configured to cause the NF to:
determine a common data network access identifier (DNAI) for a user equipment (UE), wherein the UE is part of a collection of UEs configured to use a same DNAI during a procedure of protocol data unit (PDU) session establishment for the UE; and
determine an NF of session management for the UE based on the common DNAI during the procedure of PDU session establishment.

2. The NF of access and mobility management according to claim 1, wherein the common DNAI for the UE is received from an NF of session management previously selected for the UE.

3. The NF of access and mobility management according to claim 2, wherein information related to the common DNAI is managed as group data or as traffic routing information.

4. A method of selecting a network function (NF) of session management, comprising:
determining a common data network access identifier (DNAI) for a user equipment (UE), wherein the UE is part of a collection of UEs configured to use a same DNAI during a procedure of protocol data unit (PDU) session establishment for the UE; and
determining an NF of session management for the UE based on the common DNAI during the procedure of PDU session establishment.

5. The method of selecting an NF of session management according to claim 4, wherein the common DNAI for the UE is: received from an NF of unified data repository, is retrieved from the NF of unified data repository, or is stored in an NF of access and mobility management.

6. The method of selecting an NF of session management according to claim 4, wherein the common DNAI for the UE is received from an NF of session management previously selected for the UE.

7. The method of selecting an NF of session management according to claim 5, wherein information related to the common DNAI is managed as group data or as subscription data for each UE.

8. The method of selecting an NF of session management according to claim 6, wherein information related to the common DNAI is managed as group data or as traffic routing information.

9. The method of selecting an NF of session management according to claim 7, wherein the information related to the common DNAI is associated with at least one of a group identity or correlation information indicating the collection of UEs configured to use the same DNAI.

10. The method of selecting an NF of session management according to claim 7, wherein the information related to the common DNAI is associated with at least one collection of UEs managed in a group.

11. The method of selecting an NF of session management according to claim 10, wherein each collection of UEs in the group is associated with an identifier of the collection of UEs.

12. The method of selecting an NF of session management according to claim 4, further comprising: transmitting the common DNAI to a determined NF of session management.

13. The method of selecting an NF of session management according to claim 4, further comprising: transmitting, to the UE, a domain name service (DNS) server determined based on the common DNAI during the PDU session establishment procedure.

14. The method of selecting an NF of session management according to claim 4, further comprising: transmitting, to the UE, a domain name service (DNS) server determined based on a changed common DNAI of the collection of UEs during lifetime of the established PDU session.

15. The method of selecting an NF of session management according to claim 4, wherein, when the collection of UEs configured to use same DNAI is a collection of UEs using a same edge application server (EAS), the same EAS will be mapped to a same DNAI.

16. A network function (NF), comprising:
at least one memory; and
at least one processor coupled with the at least one memory and configured to cause the NF to:
determine a common data network access identifier (DNAI) for a user equipment (UE),
wherein the UE is part of a collection of UEs configured to use a same DNAI during a protocol data unit (PDU) session establishment procedure; and
determine an NF of session management for the UE based on the common DNAI during the PDU session establishment procedure.

17. The NF of claim 16, wherein the common DNAI for the UE is received from an NF of session management previously selected for the UE.

18. The NF of claim 16, wherein information related to the common DNAI is managed as group data or as traffic routing information.

19. The NF of claim 16, wherein the at least one processor is further configured to cause the NF to: transmit, to the UE, a domain name service (DNS) server determined based on the common DNAI during the PDU session establishment procedure.

20. The NF of claim 16, wherein the at least one processor is further configured to cause the NF to: transmit, to the UE, a domain name service (DNS) server determined based on a changed common DNAI of the collection of UEs during lifetime of the established PDU session.
